(19) United States
(12) Patent Application Publication
(10) Pub. No.: US 2005/0230312 A1
(43) Pub. Date: Oct. 20, 2005

(54) Configurations and methods for reduction of microbial growth in reverse osmosis devices

(76) Inventor: Dennis Chancellor, Gilbert, AZ (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/078,866

(22) Filed: Mar. 10, 2005

Related U.S. Application Data
(60) Provisional application No. 60/552,306, filed on Mar. 10, 2004.

(51) Int. Cl. B01D 65/02

(52) U.S. Cl. 210/636; 210/764; 210/321.69; 210/321.72

(57) ABSTRACT

Microbial growth in reverse osmosis devices is reduced by incorporating an electrode into an interconnector that fluidly couples an upstream membrane unit to a downstream membrane unit. Preferably, the electrode delivers an electric field or pulse to the feed fluid at a strength effective to reduce microbial growth in the downstream membrane unit.

This application claims the benefit of our provisional patent application with the Ser. No. 60/552,306, which was filed Mar. 10, 2004, and which is incorporated by reference herein.

### FIELD OF THE INVENTION

The field of the invention is reverse osmosis water filtration systems.

### BACKGROUND OF THE INVENTION

Most reverse osmosis water filtration systems tend to accumulate, and sometimes even promote microbial growth, which in turn reduces filtration efficiency over time. There are several known manners of reducing or even eliminating microbial growth. For example, one or more bactericides may be added upstream of the filter. However, bactericides typically need to be removed and therefore add to the filtration load. Alternatively, silver coatings may be provided to reduce microbial growth. However, such approach tends to be less cost effective, and, in at least some cases, fails to reduce growth of algae. In still further known approaches, flow of water can be reversed to flush out the microbial growth. However, reversal of flow tends to only incompletely clear blockage of the filter system. Therefore, there is still a need to provide improved antimicrobial protection in reverse osmosis systems.

### SUMMARY OF THE INVENTION

The present invention is directed to fluid treatment systems adapted to significantly reduce or prevent growth of algae and/or other microorganisms. More particularly, a water filtration system applies an electrical field or current to upstream fluids, prior to their flowing into one of the filter units.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a cutaway side view of a portion of a water filtering system embodying the invention.

FIG. 2 is a cutaway end view of the system of FIG. 1.

### DETAILED DESCRIPTION

The inventors discovered that microbial growth in reverse osmosis units can be reduced if not even entirely eliminated by including an electrode in the unit that provides an electric field and/or pulse to the feed fluid upstream of at least one of several membrane units at a strength that is effective to reduce and/or eliminate microbial growth. Most preferably, contemplated reverse osmosis units will include a plurality of membrane units that are fluidly coupled to each other, and that are disposed in a pressure vessel (e.g., a pressure cylinder) from which the membrane units receive at least part of the feed fluid. Especially suitable reverse osmosis units include those described in U.S. Pat. Nos. 5,944,999, 6,149,393, and 6,521,127, all of which are incorporated by reference herein. As used herein, the term “microbial growth” refers to an increase in number and/or metabolic activity of microbial cells (including bacteria, molds, fungi, and algae).

Therefore, in one preferred aspect of the inventive subject matter, a reverse osmosis unit comprises a plurality of membrane units in a pressure vessel, wherein at least two membrane units are fluidly coupled to each other via an interconnector. Preferably, the interconnector has a cavity that receives feed fluid from the pressure vessel via a feed opening, and the interconnector is configured to fluidly couple an upstream membrane unit to a downstream membrane unit (e.g., such that permeate and/or brine flow from one membrane unit to another membrane unit through the interconnector). An electrode is further coupled to the interconnector such that the electrode provides an electric field to the feed fluid in the cavity in an amount effective to reduce microbial growth in the downstream membrane unit.

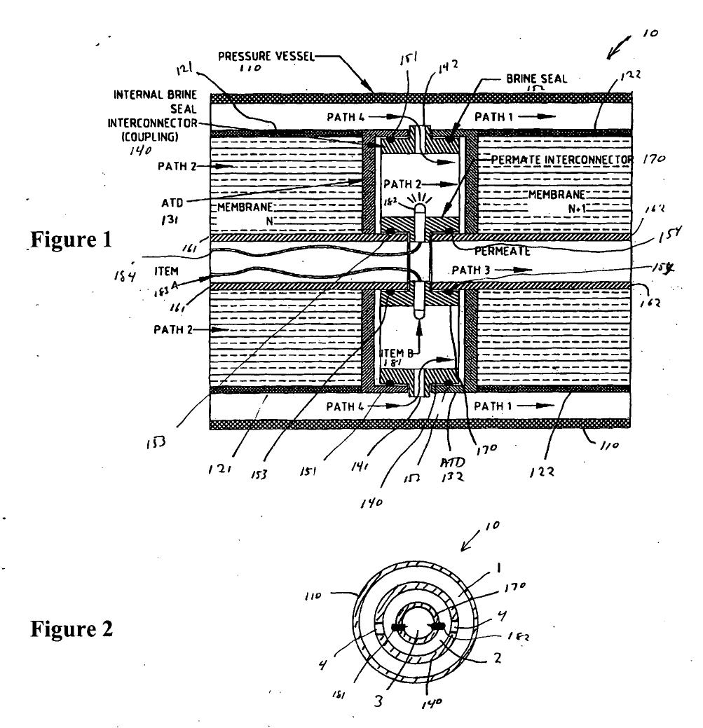

In one exemplary aspect of the inventive subject matter as depicted in FIGS. 1 and 2, a water filtering system 10 generally comprises a pressure vessel 110, which encloses the upstream and downstream membrane units 121 and 122. The membrane units 121 and 122 are separated by anti-translation devices (ATD) 131 and 132 and coupled together via interconnects 140 and 170. Brine seals 151 and 152 inhibit flow between an outside surface of interconnect 140 and ATDs 131 and 132, while brine seals 153 and 154 inhibit flow between an inside surface of interconnect 170 and permeate conduits 161 and 162. Feed fluid passes through conduits 141 and 142 from the outside of the membrane units into the cavity of the interconnector. The membrane units 121 and 122 are two of a plurality of membrane units placed end to end and coupled together in the manner shown for units 121 and 122.

The vessel, membrane units, conduits, interconnects and seals establish three flow paths (numerals 1, 2, 3) along the length of vessel 110. In operation, water to be filtered is forced into path 1, and then passes into flow path 2 via interconnecting flow paths 4. From flow path 2 a portion of the water filters through the various membrane units into permeate flow path 3 and is then directed out of the vessel 110. Flow paths 1-3 can be viewed as being formed from 3 concentric pipes where the flow paths are formed by the spaces between the walls of the pipes. In FIGS. 1 and 2, vessel 110 forms the outermost pipe, membrane units 121 and 122 in conjunction with ATDs 131 and 132 and interconnect 140 form an intermediate pipe, while conduits 161 and 162 in conjunction with interconnect 170 form the innermost pipe. Water flowing through flow paths 4 into flow path 2 from flow path 1 all pass by electrodes 181 and 182 which are coupled to an electrical source via conductors 183 and 184.

It is contemplated that causing the water in flow path 2 to pass through an electrical field generated by electrodes 181 and 182, and/or causing current to flow between electrodes 181 and 182 through the water in flow path 2 will inhibit unwanted growth of algae and other microorganisms in the filter units. As it is desirable to so treat all water flowing through the membranes, it is desirable to position the electrodes in one or more flow paths through which such water passes. It is contemplated that it is advantageous to have two or more electrodes arranged radially around flow path three and extending into flow path 2, and to route any conductors providing power to the electrodes through flow path 3.

Although shown with two electrodes, alternative embodiments may utilize a single electrode, more than two electrodes, or some other method for subjecting the water in path two to electricity. In some instances, one or more walls of the pressure vessel, an ATD or other interconnect may function as an electrode. As an example, if pressure vessel 110 comprises a conductive material, it may function as an electrode. Similarly, if interconnects 140 and 170 are each conductive, each interconnect can operate as an electrode to apply a field and/or current to water flowing between the interconnects. Electrodes may be formed from any conductive materials. Most preferably, however, the electrodes are formed from high surface carbon, or metals, which may be coated, alloyed, or otherwise comprise titanium, platinum, or other noble metals. Thus, an electric field or pulse may be formed in a space between the electrode and a component of the reverse osmosis device, and/or a space between two electrodes.

With respect to the type of electrodes and electric field, it should be appreciated that numerous variations can be made without departing from the inventive concept presented herein. For example, one or more electrodes may be employed to provide a continuous electrical field (using DC or AC). While not limiting to the inventive subject matter, such electrical fields will have a relatively low voltage (i.e., between several millivolt and up to 500 Volt [in some instances even higher]), and are most preferably continuous. However, pulsed electrical fields, or fields with alternating polarity are also deemed suitable herein. Depending on the chemical composition of the feed fluid and other considerations (e.g., electrode material, tolerance to electrofouling, oxidation of components in the feed fluid etc.), the electrodes and electrical field may be configured such that oxygen radicals and hydroxyl radicals are generated from the water in the feed fluid. Such radicals are known to have a direct antimicrobial effect, and the quantity of such radicals can be regulated by regulating electrolysis.

On the other hand, the reverse osmosis system may also include two electrodes that are configured and arranged to provide an electric pulse, and most preferably a high-voltage pulse. Such pulse treatment preferably achieves electroporation of a microorganism, and suitable voltages will be in the range of 500 Volt to several 10,000 Volt (and even higher) at a gap between the electrodes of about several millimeter to several centimeters. Similarly, the electrodes may also be used to deliver a high-frequency electrical field that has a strength and frequency to disrupt microbial growth. Additionally, or alternatively, the electrodes may be configured as ultrasonic transducers that provide continuous or intermittent sonication of the feed fluid in a position upstream of the downstream membrane unit. In further contemplated aspects, the electrodes may comprise a silver mesh or other component, wherein a physical property of the electrode other than its conductivity may contribute to the reduction and/or elimination of the microbial growth.

Although shown in relation to a filtration system having filter units coupled end to end in a serial fashion, it is contemplated that using electrical fields and/or current to reduce microbial growth prior to filtering is equally applicable to systems having other configurations and/or used to treat other types of liquids. In some instances, electrical treatment may be limited to a small portion of the system wherein in other instances substantially all of the water in the system may be subjected to treatment. Similarly, in some instances water will be treated prior to filtration while in others it, and the filters it is passing through, will be treated as it passes through a filter.

Therefore, the inventors also contemplate a method of reducing microbial growth in a reverse osmosis unit. In one step of such methods, an upstream membrane unit is fluidly coupled to a downstream membrane unit via an interconnector that has a cavity that receives a feed fluid from a pressure vessel via a feed opening. In another step, electricity is applied to one or more than one electrodes disposed in the cavity of the interconnector, wherein the electricity is applied in an amount effective to reduce microbial growth in the downstream membrane unit. With respect to the components of contemplated methods, the same considerations as provided above apply.

Thus, specific embodiments and applications of reduction of microbial growth in reverse osmosis devices have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

1. A reverse osmosis system comprising:
an interconnector having a cavity that receives a feed fluid from a pressure vessel via a feed opening, and wherein the interconnector is configured to fluidly couple an upstream membrane unit to a downstream membrane unit; and
an electrode coupled to the interconnector such that the electrode provides an electric field to the feed fluid in the cavity in an amount effective to reduce microbial growth in the downstream membrane unit.

2. The reverse osmosis system of claim 1 wherein the pressure vessel is a pipe that encloses the upstream membrane unit and downstream membrane unit.

3. The reverse osmosis system of claim 1 wherein the interconnector has a second feed opening and a second electrode.

4. The reverse osmosis system of claim 1 wherein the interconnector has a toroid shape and is sealingly coupled to a permeate path and a feed fluid path.

5. The reverse osmosis system of claim 1 wherein the electrode is configured to provide an at least temporarily continuous electrical field.

6. The reverse osmosis system of claim 1 wherein the electrical field is in a location selected from the group consisting of a space between the electrode and a component of the reverse osmosis system and a space between the electrode and a second electrode.

7. The reverse osmosis system of claim 5 wherein the electrical field has a strength that is sufficient to generate a hydroxyl radical from water.

8. The reverse osmosis system of claim 1 further comprising a second electrode, wherein the electrode and the second electrode are configured to provide an electric pulse.

9. The reverse osmosis system of claim 8 wherein the electric pulse has a strength sufficient to electroporate a microorganism.

10. The reverse osmosis system of claim 5 wherein the electrode is configured to provide a high-frequency electrical field.

11. A method of reducing microbial growth in a reverse osmosis unit, comprising:
fluidly coupling an upstream membrane unit to a downstream membrane unit via an interconnector having a cavity that receives a feed fluid from a pressure vessel via a feed opening; and
applying an electricity to an electrode that is disposed in the cavity of the interconnector in an amount effective to reduce the microbial growth in the downstream membrane unit of the reverse osmosis unit.

12. The method of claim 11 wherein the upstream and downstream membrane units are disposed in pressure vessel.

13. The method of claim 11 wherein the electrode generates at least one of a continuous electric field, a high-frequency electric field, and an electric pulse.
